(19) United States
(12) Patent Application Publication
(10) Pub. No.: US 2025/0236517 A1
(43) Pub. Date: Jul. 24, 2025

(54) DEHYDROGENATION REACTION DEVICE

(71) Applicants: HYUNDAI MOTOR COMPANY, SEOUL (KR); KIA CORPORATION, SEOUL (KR)

(72) Inventors: Jaeyong Lee, Hwaseong-si (KR); Pyung Soon Kim, Hwaseong-si (KR); Jihui Seo, Hwaseong-si (KR); Hanjin Kim, Hwaseong-si (KR); Narae Yoon, Hwaseong-si (KR); Jihye Park, Hwaseong-si (KR)

(73) Assignees: HYUNDAI MOTOR COMPANY, SEOUL (KR); KIA CORPORATION, SEOUL (KR)

(21) Appl. No.: 18/745,026

(22) Filed: Jun. 17, 2024

(30) Foreign Application Priority Data
Jan. 23, 2024 (KR) 10-2024-0009980

(51) Int. Cl. C01B 3/06; B01J 8/00; B01J 8/02

(52) U.S. Cl. CPC C01B 3/065; B01J 8/008; B01J 8/0285; B01J 2219/00063; B01J 2219/00074

(57) ABSTRACT

A dehydrogenation reaction device includes a chemical hydride storage unit including a chemical hydride storage tank, a reaction unit including an acid aqueous solution storage tank, and a dehydrogenation reactor configured to generate hydrogen by reacting a chemical hydride with an acid aqueous solution, and a hydrogen storage unit including a hydrogen storage tank configured to store the hydrogen produced in the dehydrogenation reactor. The dehydrogenation reactor includes a body portion made of a metal and a reinforcement portion surrounding the outer surface of the body portion and including fiber reinforced plastic (FRP).

### CROSS REFERENCE TO RELATED APPLICATIONS

This application claims priority to and the benefit of Korean Patent Application No. 10-2024-0009980 filed in the Korean Intellectual Property Office on Jan. 23, 2024, the entire contents of which are incorporated herein by reference.

### BACKGROUND

### (a) Field

The present disclosure relates to a dehydrogenation reaction device for supplying hydrogen to a fuel cell.

### (b) Description of the Related Art

Due to depletion of fossil energy and environmental pollution problems, there is a great demand for renewable and alternative energy, and hydrogen is attracting attention as one of such alternative energies.

A fuel cell and a hydrogen combustion device use hydrogen as a reaction gas, and in order to apply the fuel cell and the hydrogen combustion device to vehicles and various electronic products for example, a stable and continuous supply technology of hydrogen is required.

In order to supply hydrogen to a device that uses hydrogen, a method of receiving hydrogen whenever hydrogen is needed from a separately installed hydrogen supply source may be used. In this way, compressed hydrogen or liquid hydrogen may be used.

Alternatively, a method of generating hydrogen through a reaction of a corresponding material after mounting a material in which hydrogen is stored on a device using hydrogen and supplying it to the device using hydrogen may be used. For this method, for example, a method of dissolving a solid hydride in an aqueous solution, a method of using adsorption and desorption (absorbents/carbon), a chemical method (chemical hydrogen storage), and the like have been proposed.

As an example, a system for producing hydrogen by injecting an acid solution into NaBH₄ is known. This hydrogen production system is a batch type system including an acid aqueous solution tank, a reactor including NaBH₄, a water separator, an acid purifier, and the like.

However, solid-phase hydrogen-storing materials such as NaBH₄ and the like, from which hydrogen may be extracted through hydrolysis, are required of a reactor capable of withstanding high-temperature/high-pressure environment conditions, for example, greater than or equal to about 100° C. and greater than or equal to about 10 bars, due to an intense exothermicity reaction and generation of a large amount of hydrogen during the large-scale dehydrogenation reaction.

However, a reactor made of an STS material may satisfy the high-pressure operation condition, but the higher pressure, the thicker and heavier the reactor, which hinders construction of a compact reaction system.

### SUMMARY

An embodiment provides a dehydrogenation reaction device capable of withstanding reaction heat generated during a dehydrogenation reaction of chemical hydride and a pressure, smoothing generating and storing hydrogen therefrom, and constructing a lightweight and compact reaction system.

According to an embodiment, a dehydrogenation reaction device includes a chemical hydride storage unit including a chemical hydride storage tank, a reaction unit including an acid aqueous solution storage tank, and a dehydrogenation reactor configured to generate hydrogen by reacting a chemical hydride with an acid aqueous solution, and a hydrogen storage unit including a hydrogen storage tank configured to store the hydrogen produced in the dehydrogenation reactor, wherein the dehydrogenation reactor includes a body portion made of a metal and a reinforcement portion surrounding the outer surface of the body portion and including fiber reinforced plastic (FRP).

The metal of the body portion may be a chemical-resistant metal including austenitic stainless steel or aluminum.

The fiber reinforced plastic may include a resin and a fiber within the resin.

The resin may include an epoxy resin including phenolic glycidyl ethers, novolacs, aromatic glycidyl amines, aliphatics, cycloaliphatics, or hybrids thereof; a cyanate ester resin including a tricyanate ester resin or a dicyanate ester; a bismaleimide (BMI) resin; a polyimide (PI) resin; or a combination thereof.

The fiber may include a carbon fiber, a glass fiber, an aramid fiber, a basalt fiber, a polyethylene terephthalate (PET) fiber, or a combination thereof.

The dicyanate ester resin may include a compound represented by Chemical Formula 1.

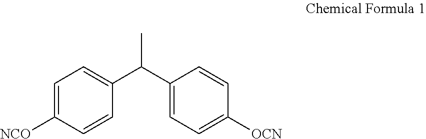

The tricyanate ester resin may include a compound represented by Chemical Formula 2.

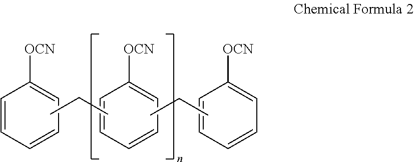

In Chemical Formula 2, n is an integer of 0 or 1.

The resin may have a viscosity of about 10 cps to about 20000 cps at room temperature (20° C.).

The first resin and the second resin may be mixed at a weight ratio of about 10:90 to about 90:10.

The resin may be primarily cured at about 100° C. to about 200° C. for about 30 minutes to about 360 minutes and then post-cured at about 200° C. to about 300° C. for about 30 minutes to about 360 minutes.

The resin may have a glass transition temperature (Tg) of about 100° C. to about 450° C.

The body portion of the dehydrogenation reactor may include a cylindrical cylinder portion, hemispherical first and second dome portions at both ends of the cylinder portion, and lines including a hydrogen discharge line at one end of the first dome portion or one end of the second dome portion, an acid aqueous solution supply line, a heat medium supply line, a heat medium discharge line, a product discharge line, a chemical hydride supply line, or a combination thereof.

The reinforcement portion may surround at least a portion of the cylinder portion and the first and second dome portions of the body portion.

The dehydrogenation reactor may further include a thermal control device configured to control an internal temperature of the dehydrogenation reactor.

The heat control device may be disposed in a coil shape along the inside or outside of the dehydrogenation reactor and may include a pipe line made of copper or steel.

One end of the first dome portion of the dehydrogenation reactor may further include a heat medium supply line and a heat medium discharge line which supply and discharge a heat medium including an aqueous liquid refrigerant, an oil-based liquid refrigerant, a fluorine-based gas refrigerant, an inorganic compound-based gas refrigerant, or a combination thereof, flowing along the pipe line.

One end of the first dome portion or one end of the second dome portion of the dehydrogenation reactor may further include sensing lines that measure a temperature or pressure inside the dehydrogenation reactor.

One end of the first dome portion or one end of the second dome portion of the dehydrogenation reactor may include a manifold portion.

The hydrogen discharge line, the aqueous acid solution supply line, the heat medium supply line, the heat medium discharge line, the product discharge line, the chemical hydride supply line, the sensing line, or the combination thereof may be located in the manifold portion.

The dehydrogenation reaction device according to an embodiment can withstand reaction heat and pressure generated during the dehydrogenation reaction of solid-phase chemical hydride, can smoothly generate and store hydrogen, and can construct a lightweight and compact reaction system.

### BRIEF DESCRIPTION OF THE FIGURES

FIG. 1 is a view schematically showing a dehydrogenation reaction device according to an embodiment.

FIG. 2 is a perspective view showing a dehydrogenation reactor.

FIG. 3 is a perspective view of the dehydrogenation reactor of FIG. 2 taken along line A-A′.

FIG. 4 is a perspective view and a plan view showing a dome portion of a dehydrogenation reactor according to some embodiments.

FIG. 5 is a perspective view and a plan view showing a dome portion of a dehydrogenation reactor according to some embodiments.

### DETAILED DESCRIPTION

The advantages, features, and aspects to be described hereinafter will become apparent from the following description of the embodiments with reference to the accompanying drawings, which is set forth hereinafter. However, the present disclosure may be not limited to embodiments that are described herein. Although not specifically defined, all of the terms including the technical and scientific terms used herein have meanings understood by ordinary persons skilled in the art. The terms have specific meanings coinciding with related technical references and the present specification as well as lexical meanings. That is, the terms are not to be construed as having idealized or formal meanings. Throughout the specification and claims which follow, unless explicitly described to the contrary, the word “comprise/include” or variations such as “comprises/includes” or “comprising/including” will be understood to imply the inclusion of stated elements but not the exclusion or any other elements.

The terms of a singular form may include plural forms unless referred to the contrary.

In the drawings, the thickness of layers, films, panels, regions, etc., are exaggerated for clarity. Like reference numerals designate like elements throughout the specification.

It will be understood that when an element such as a layer, film, region, or substrate is referred to as being “on” another element, it may be directly on the other element or intervening elements may also be present. In contrast, when an element is referred to as being “directly on” another element, there are no intervening elements present.

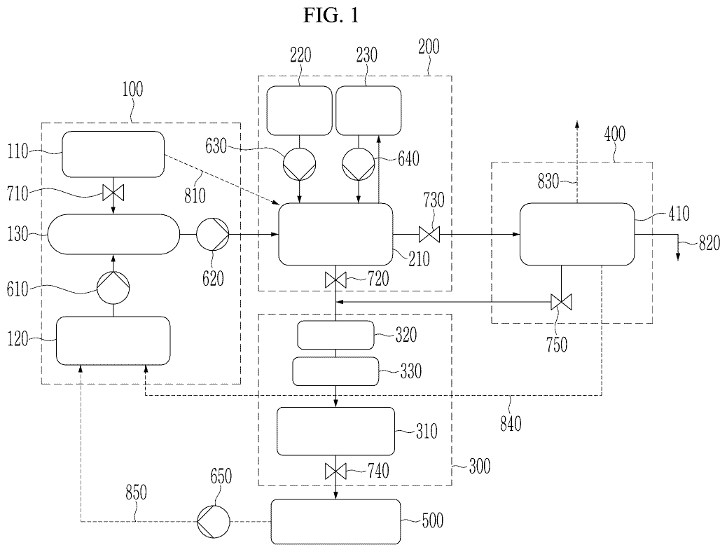

FIG. 1 is a view schematically showing a dehydrogenation reaction device according to an embodiment. Hereinafter, the dehydrogenation reaction device will be described with reference to FIG. 1.

Referring to FIG. 1, the dehydrogenation reaction device includes a chemical hydride storage unit 100, a reaction unit 200, a hydrogen storage unit 300, and a recovery unit 400.

The chemical hydride storage unit 100 includes a chemical hydride storage tank 110 including chemical hydride.

For example, the chemical hydride may be charged into the chemical hydride storage tank 110 in a solid state.

For example, the chemical hydride in the solid state may be in the form of any one of powders, granules, beads, microcapsule, and pellets. When chemical hydride is stored in an aqueous solution state (a concentration of chemical hydride: about 20%), a large amount of chemical hydride cannot be stored, but when chemical hydride is stored in a solid state, large-capacity storage may be possible.

The chemical hydride may be any compound that is hydrolyzed to produce hydrogen and a hydrolysate, for example, NaBH₄, LiBH₄, KBH₄, NH₄BH₄, NH₃BH₃, (CH₃)₄NH₄BH₄, NaAlH₄, LiAlH₄, KAlH₄, Ca(BH₄)₂, Mg(BH₄)₂, NaGaH₄, LiGaH₄, KGaH₄, LiH, CaH₂, MgH₂, or a mixture thereof.

The chemical hydride storage tank 110 may include an alkali hydroxide further including NaOH, KOH, LiOH, CsOH, or a combination thereof as a stabilizer, together with the chemical hydride.

Optionally, the chemical hydride storage unit 100 may further include a water storage tank 120 and a mixer 130.

The water storage tank 120 stores water, and the mixer 130 is supplied with the chemical hydride from the chemical hydride storage tank 110 and with the water from the water storage tank 120 and then, the chemical hydride and the water are mixed, preparing a chemical hydride aqueous solution. The mixer 130 may prepare the chemical hydride aqueous solution by heating and stirring the chemical hydride and the water in order to well mix them.

The chemical hydride aqueous solution may include about 20 wt % to about 80 wt % of the chemical hydride, about 1 wt % to about 10 wt % of a stabilizer, and a balance amount of the water and for example, at a room temperature (about 20° C.), about 20 wt % to about 35 wt % of the chemical hydride, about 1 wt % to about 5 wt % of the stabilizer, and a balance amount of the water. At a higher temperature than the room temperature, the chemical hydride and the stabilizer may be dissolved in a higher concentration. In the room temperature environment, when the content of the chemical hydride is less than about 20 wt % in the chemical hydride aqueous solution, the chemical hydride may be sufficiently dissolved but reduce a hydrogen storage in terms of the system, and when the content is greater than about 35 wt %, the chemical hydride may be precipitated in the aqueous solution due to the overconcentration, and the aqueous solution may be difficult to quantitatively inject, and when the content of the stabilizer is less than about 1 wt %, hydrogen bubbles may be generated due to the reaction of the chemical hydride and the water, the aqueous solution may be difficult to quantitatively inject, but when the content is greater than about 5 wt %, an acid aqueous solution may be additionally injected thereinto to adjust pH for hydrogen generation. However, for long-term storage of the chemical hydride aqueous solution, the stabilizer may be added up to about 40 wt % at maximum.

For example, the chemical hydride storage unit 100 may inject the chemical hydride directly from the chemical hydride storage tank 110 to the dehydrogenation reactor 210 (810) or supply the chemical hydride aqueous solution to the dehydrogenation reactor 210.

The chemical hydride in a solid state may be transported by using pneumatics or gravity or using a metering device equipped with a mechanically moving part. For example, the chemical hydride storage unit 100 may include a first valve 710 for transporting the chemical hydride form the chemical hydride storage tank 110 to the mixer 130 or the dehydrogenation reactor 210.

In addition, the chemical hydride storage unit 100 may further include a first pump 610 for transporting the water from the water storage tank 120 to the mixer 130 and a second pump 620 for transporting the chemical hydride aqueous solution to the dehydrogenation reactor 210.

The reaction unit 200 includes an acid aqueous solution storage tank 220 and a dehydrogenation reactor 210.

The acid aqueous solution storage tank 220 stores the acid aqueous solution.

The acid may be an inorganic acid such as sulfuric acid, nitric acid, phosphoric acid, boric acid, or hydrochloric acid, an organic acid such as heteropoly acid, acetic acid, formic acid, malic acid, citric acid, tartaric acid, ascorbic acid, lactic acid, oxalic acid, succinic acid, tauric acid, or a mixture thereof, because the molecular weight is small compared to proton, and the system weight may be reduced and formic acid (HCOOH) may be used as it is safer than hydrochloric acid in a high concentration state. In the case of formic acid, as a weak acid, the pH is maintained at about 2 under the conditions described in the present disclosure, so it may be used relatively safely. In addition, captured carbon dioxide may be obtained through hydrogenation, and thus it is an important material in terms of a recycling/recycling of carbon dioxide. In addition, formate is converted to bicarbonate through a dehydrogenation reaction, whereby additional hydrogen may be obtained.

The acid aqueous solution storage may have a corrosion-resistant protective layer such as TEFLON (tetrafluoroethylene) coating to prevent corrosion by the first acid aqueous solution.

In the dehydrogenation reactor 210, a dehydrogenation reaction in which hydrogen is produced by a hydrolysis reaction of a chemical hydride by the acid aqueous solution proceeds. The acid aqueous solution adjusts the pH of the chemical hydride so that the dehydrogenation reaction may be promoted.

For example, when the chemical hydride is NaBH₄ and the acid is HCOOH, the dehydrogenation reaction occurs, as shown in Reaction Formula 1.

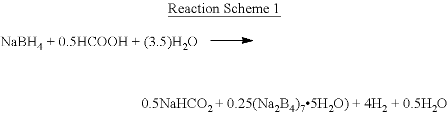

The chemical hydride aqueous solution may be injected into the dehydrogenation reactor 210 at the same time as the acid aqueous solution or after first injecting the acid aqueous solution. Herein, the chemical hydride aqueous solution may be heated to about 30° C. to about 80° C. to prevent precipitation and then, injected into the dehydrogenation reactor 210.

The dehydrogenation reactor 210 may include a first nozzle for spraying the chemical hydride aqueous solution and a second nozzle for spraying the acid aqueous solution, wherein the first nozzle and the second nozzle may be disposed close to each other so that the chemical hydride aqueous solution and the acid aqueous solution may contact within about 3 seconds after discharging the water or induce rapid injection. In addition, the first nozzle or the second nozzle includes a radial injector at the nozzle tip to induce a uniform reaction through atomization of the solution.

In the dehydrogenation reactor 210, the acid may react in a mole ratio of about 0.25 to about 1 based on 1 mole of the chemical hydride, and water may react in a mole ratio of about 2 to about 4 based on 1 mole of the chemical hydride. If the mole ratio of the acid is less than about 0.25 or the mole ratio of water is less than about 2, the conversion rate may decrease, and if the mole ratio of the acid exceeds about 1 or the mole ratio of the water exceeds about 4, the hydrogen storage capacity may decrease.

When the acid aqueous solution is used to generate hydrogen from the chemical hydride, water is easily vaporized due to an exothermic reaction (a water vaporization temperature: 100° C. @ 1 bar), so that the amount of produced hydrogen (i.e., a hydrogen storage capacity) may be deteriorated.

Therefore, the dehydrogenation reaction may take place under high-temperature and high-pressure conditions. This prevents vaporization of water and reduces the amount of the used water, thereby maximizing the amount of produced hydrogen (water vaporization temperature: 175° C. @ 10 bar, 260° C. @ 50 bar). In addition, the generation of CO₂ may also be suppressed through the pressurization operation of the dehydrogenation reactor 210.

Also, if excess water is included in a hydrogen gas after the reaction, a separate gas-liquid separator is required, and accordingly the volume and weight of the entire system may be increased and then the hydrogen storage capacity may be decreased, but high-temperature and high-pressure operation of the dehydrogenation reactor 210 may increase the hydrogen storage capacity and reduce the system cost and weight.

For example, in the case of the system using NaBH₄ and formic acid (HCOOH), the temperature of the dehydrogenation reaction may be about 10° C. to about 400° C., or about 100° C. to about 250° C. When the temperature of the dehydrogenation reaction is less than about 10° C., the acid or acid aqueous solution may be coagulated or separated, and when the temperature exceeds about 400° C., a side reaction such as an occurrence of carbon monoxide may increase.

The pressure of the dehydrogenation reaction may be about 1 bar to about 100 bar, or about 5 bar to about 50 bar. If the pressure of the dehydrogenation reaction is less than about 1 bar, a decompression pump is required, which may unnecessarily increase the system weight, and if it exceeds about 100 bar, the weight and volume of a high-temperature/high-pressure container may increase.

Accordingly, the gas product produced in the dehydrogenation reactor 210 may contain about 99 volume % or more of hydrogen, about 1 volume % or less of water, and about 0.1 volume % or less of other impurities.

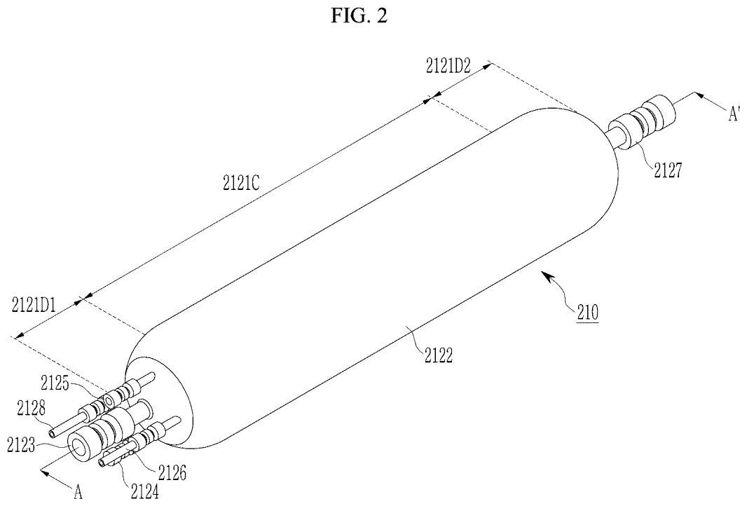

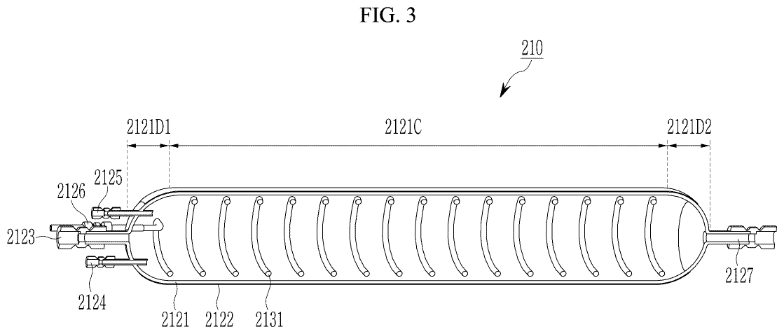

FIG. 2 is a perspective view showing a dehydrogenation reactor according to an embodiment and FIG. 3 is a perspective view of the dehydrogenation reactor of FIG. 2 taken along the line A-A′. Hereinafter, the dehydrogenation reactor will be described with reference to FIGS. 2 and 3.

Referring to FIGS. 2 and 3, the dehydrogenation reactor 210 may be configured as a high-temperature and high-pressure vessel so that the dehydrogenation reaction may be performed under high-temperature and high-pressure conditions. As an example, the dehydrogenation reactor 210 may include a body portion 2121 and a reinforcement portion 2122.

The body portion 2121 may have a shape such as a cylinder, a sphere, a cuboid, or a polygonal prism, and in particular may have a cylindrical shape. As an example, the body portion 2121 may have a cylindrical cylinder portion 2121C, and hemispherical first and second dome portions 2121D1 and 2121D2 located at both ends of the cylinder portion 2121C. For example, a diameter of the cylinder portion 2121C may be constant along the longitudinal direction, and diameters of the first and second dome portions 2121D1 and 2121D2 may gradually increase as they move away from the cylinder portion 2121C along the longitudinal direction.

The metal of the body portion 2121 may be made of a chemical-resistant metal including stainless steel or aluminum, which is resistant to chemicals such as acids/bases and hydrogen embrittlement. For example, the stainless steel may be austenitic stainless steel, and the aluminum may be 6000 series or 7000 series aluminum.

For example, the body portion 2121 may be manufactured by rolling up a metal liner and welding it, or if a structure stronger against internal pressure is needed, it may be manufactured using a seamless cylinder (e.g., seamless steel pipe). At this time, the cylinder portion 2121C and the dome portions 2121D1 and 2121D2 of the body portion 2121 may be integrated without welding any joints.

The reinforcement portion 2122 surrounds the outer surface of body portion 2121. Accordingly, the reinforcement portion 2122 can improve the pressure resistance characteristics of the body portion 2121.

As an example, the reinforcement portion 2122 may surround at least a portion of the cylinder portion 2121C and the first and second dome portions 2121D1 and 2121D2 of the body portion 2121, and for example, the reinforcement portion 2122 may surround the first and second dome portions 2121D1 and 2121D2, may not surround the first and second dome portions 2121D1 and 2121D2, or may surround a space between the first and second domes 2121D1 and 2121D2 and the cylinder portion 2121C.

The reinforcement portion 2122 may include fiber reinforced plastic (FRP). As an example, the fiber reinforced plastic may include a resin and fibers within the resin.

As an example, the resin may have a viscosity of about 10 cps to about 20,000 cps at room temperature (20° C.) and a glass transition temperature (Tg) of about 100° C. to about 450° C. Such a resin may include an epoxy resin, a cyanate ester resin, a bismaleimide (BMI) resin, a polyimide (PI) resin, or a combination thereof. Herein, the resin may be a mixture of the first resin and the second resin at a weight ratio of about 10:90 to about 90:10, and the first resin may be any one of an epoxy resin, a cyanate ester resin, a bismaleimide resin, or a polyimide resin and the second resin may be any one different from the first resin.

For example, the epoxy resin may include phenolic glycidyl ethers, novolacs, aromatic glycidyl amines, aliphatics, cycloaliphatics, or hybrids thereof.

For example, it may include a cyanate ester resin, a tricyanate ester resin, or a dicyanate ester resin.

In particular, when a resin having a glass transition temperature of 200° C. or higher is required, the dicyanate ester resin may include a compound represented by Chemical Formula 1.

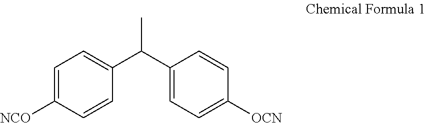

For example, the tricyanate ester resin may include a compound represented by Chemical Formula 2.

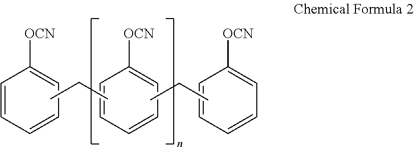

In Chemical Formula 2, n may be an integer of 0 or 1.

The resin may be primarily cured by heating at about 100° C. to about 200° C. for about 30 to about 360 minutes using an oven, etc. Thereafter, in order to improve thermal/structural properties, it may be post-cured by heating in an oven at about 200° C. to about 300° C. for about 30 minutes to about 360 minutes.

As an example, the fiber may include a carbon fiber, a glass fiber, an aramid fiber, a basalt fiber, a polyethylene terephthalate (PET) fiber, or a combination thereof. Additionally, the fiber may be in a form of a multiaxis non-crimp fabric or a multiaxial woven fabric in which a plurality of unidirectional fabrics are stacked at an intersection angle.

The reinforcement portion 2122 may be bonded to the body portion 2121 by impregnating fibers in a resin having a glass transition temperature (Tg) of 100° C. or higher, wrapping the fibers around the outer surface of the reinforcement portion 2122, and then curing the fibers. After the resin is completely cured, the resin may have a glass transition temperature (Tg) of about 100° C. to about 450° C., and in order to further protect the resin or the reinforcement portion 2122, a resin composition with a glass transition temperature of about 100° C. or more may be coated and cured on the outer surface.

In this way, as the body portion 2121 is made of the chemical-resistant metal which is resistant to chemicals such as acids/bases and hydrogen embrittlement, and the external surface of the body portion 2121 is surrounded with the reinforcement portion 2122 including fiber-reinforced plastic, the dehydrogenation reactor 210 may withstand reaction heat of about 100° C. or more and a pressure of about 10 bars or more during the dehydrogenation reaction of solid-phase chemical hydride, smoothly generate and store hydrogen, but have a smaller thickness that that made of a heavy metal material and thus contribute to constructing a light and compact reaction system.

One end of the first dome portion 2121D1 may include a hydrogen discharge line 2123, an acid aqueous solution supply line 2124, a heat medium supply line 2126, a heat medium discharge line 2128, sensing lines 2125, or a combination thereof. One end of the first dome portion 2121D1 of the dehydrogenation reactor 210 may further include a manifold portion 2121M and the hydrogen discharge line 2123, the acid aqueous solution supply line 2124, the heat medium supply line 2126, the heat medium discharge line 2128, the sensing lines 2125, or the combination thereof may be located in the manifold portion 2121M.

Meanwhile, one end of the second dome portion 2121D2 may further include a product discharge line 2127. The product discharge line 2127 may discharge hydrogen and other products generated in the dehydrogenation reactor 210 to the outside of the dehydrogenation reactor 210.

In addition, a chemical hydride supply line is independently disposed at one end of the first dome portion 2121D1 or one end of the second dome portion 2121D2, or the hydrogen discharge line 2123, the sensing lines 2125, or the product discharge line 2127 may be used as the chemical hydride supply line.

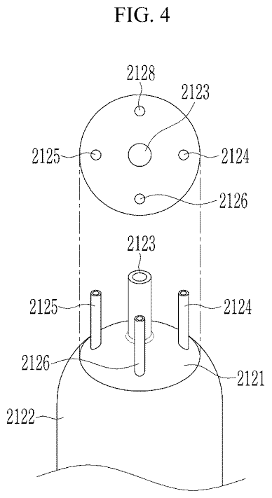

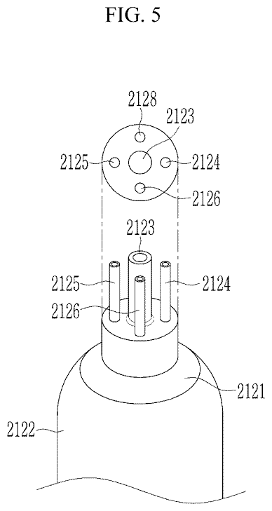

However, the present disclosure is not limited thereto, but the hydrogen discharge line 2123, the acid aqueous solution supply line 2124, the heat medium supply line 2126, the heat medium discharge line 2128, the sensing lines 2125, the product discharge line 2127, or the chemical hydride supply line may be freely arranged in the first dome portion 2121D1 or the second dome portion 2121D2 depending on the convenience of piping arrangement or connection of the dehydrogenation reaction device. FIGS. 4 and 5 are perspective views and plan views showing the dome portion of the dehydrogenation reactor according to some example embodiments.

Referring to FIG. 4, the hydrogen discharge line 2123, the acid aqueous solution supply line 2124, the heat medium supply line 2126, the heat medium discharge line 2128, and the sensing lines 2125 are located at one end of the first dome portion 2121D1. For example, the hydrogen discharge line 2123 is located at the central portion of one end of the first dome portion 2121D1, but the acid aqueous solution supply line 2124, the heat medium supply line 2126, the heat medium discharge line 2128, and the sensing lines 2125 are located around the hydrogen discharge line 2123. However, the present disclosure is not limited thereto, but the hydrogen discharge line 2123, the acid aqueous solution supply line 2124, the heat medium supply line 2126, the heat medium discharge line 2128, and the sensing lines 2125 may be disposed around the central portion of one end of the first dome portion 2121D1.

In addition, the present disclosure is not limited, but the lines located at one end of the first dome portion 2121D1 may be configured to consist of at least two lines selected from the hydrogen discharge line 2123, the acid aqueous solution supply line 2124, the heat medium supply line 2126, the heat medium discharge line 2128, sensing lines 2125, the product discharge line 2127, or the chemical hydride supply line.

Referring to FIG. 5, one end of the first dome portion 2121D1 of the dehydrogenation reactor 210 further includes a manifold portion 2121M, in which the hydrogen discharge line 2123, the acid aqueous solution supply line 2124, the heat medium supply line 2126, the heat medium discharge line 2128, the sensing lines 2125, or a combination thereof may be disposed. For example, the hydrogen discharge line 2123 may be disposed at the central portion of the manifold portion 2121M, but the acid aqueous solution supply line 2124, the heat medium supply line 2126, the heat medium discharge line 2128, and the sensing lines 2125 may be disposed around the hydrogen discharge line 2123. However, the present disclosure is not limited thereto, but the hydrogen discharge line 2123, the acid aqueous solution supply line 2124, the heat medium supply line 2126, the heat medium discharge line 2128, and the sensing lines 2125 may be disposed around the central portion of the manifold portion 2121M.

The present disclosure still is not limited thereto, but one end of the second dome portion 2121D2 of the dehydrogenation reactor 210 also may further include the manifold portion 2121M.

In addition, the present disclosure is not limited, but the lines located in the manifold portion 2121M may be configured to consist of at least two lines selected from the hydrogen discharge line 2123, the acid aqueous solution supply line 2124, the heat medium supply line 2126, the heat medium discharge line 2128, the sensing lines 2125, the product discharge line 2127, or the chemical hydride supply line.

Because the hydrogen generation reaction inside the dehydrogenation reactor 210 is an exothermic reaction, a heat control device for adjusting an internal temperature of the dehydrogenation reactor 210 may be further provided. The heat control device may be disposed inside or outside the body portion 2121.

For this purpose, the heat control device includes a pipe line 2131 through which a heat medium flows (or circulates) in the dehydrogenation reactor 210, so that the heat medium may flow (or circulate) inside the pipe line 2131.

The pipe line 2131 may be formed as a spiral coil shape along the inside or the outside of the dehydrogenation reactor 210. As the pipe line 2131 is formed as the spiral coil shape, a heat exchange area inside or outside the body portion 2121 of the dehydrogenation reactor 210 may be maximized.

The pipe line 2131 may be made of a metal-based material including copper or steel and coated with TEFLON (tetrafluoroethylene) on the surface in order to prevent corrosion by acid or base.

For example, if the pipe line 2131 may be equipped at the outside of the dehydrogenation reactor 210, the coil shaped pipe line 2131 may be equipped to be larger than a diameter of the outer circumferential surface of the body portion 2121. Herein, the coil shaped pipe line 2131 may be installed to contact the external circumferential surface of the body portion 2121. Because the pipe line 2131 is equipped to contact the external circumferential surface of the body portion 2121 of the dehydrogenation reactor 210, heat generated inside the body portion 2121 may be quickly transferred to the pipe line 2131.

The heat medium flowing along the inside of the pipe line 2131 may include an aqueous liquid refrigerant, an oil-based liquid refrigerant, a fluorine-based gas refrigerant, and an inorganic compound-based gas refrigerant, or a combination thereof.

The heat medium may be supplied to the pipe line 2131 through the heat medium supply line 2126 located at one end of the first dome portion 2121D1 of the dehydrogenation reactor 210, flow along the inside of the pipe line 2131, and discharged from the pipe line 2131 through the heat medium discharge line 2128 located at one end of the first dome portion 2121D1 of the dehydrogenation reactor 210.

On the other hand, a heat exchanger for cooling the heat medium flowing along the pipe line 2131 may be included. The heat exchanger may be an air- or water-cooled radiator or a plate heat exchanger. If necessary, the heat exchanger may be used in common with an air compressor provided in vehicles.

In addition, in order to circulate the heat medium through the pipe line 2131, a pump may be provided between the heat exchanger and the body portion 2121 of the dehydrogenation reactor 210.

On the other hand, the sensing lines 2125 may be a thermometer or a pressure sensor for measuring a temperature or a pressure inside the dehydrogenation reactor 210, wherein the sensing lines 2125 may serve individually or in combination.

For example, the hydrogen discharge line 2123, the acid aqueous solution supply line 2124, the heat medium supply line 2126, the heat medium discharge line 2128, and the sensing lines 2125 may be intubated and fixed through welding or threading in one end of the first dome portion 2121D1 or in the manifold portion 2121M. The hydrogen discharge line 2123, the acid aqueous solution supply line 2124, the heat medium supply line 2126, the heat medium discharge line 2128, and the sensing lines 2125 may be intubated and fixed through individual or group quick couplers to facilitate attachment and detachment from the body portion 2121, wherein the quick couplers must be able to withstand changes in reaction conditions such as a temperature, a pressure, and the like.

In addition, the hydrogen discharge line 2123, the acid aqueous solution supply line 2124, the heat medium supply line 2126, the heat medium discharge line 2128, and the sensing lines 2125, if it is difficult to withstand an internal pressure by welding alone, may be fixed as a manifolded line through a thread formed on an inner diameter of the manifold portion 2121M, and the manifold portion 2121M may also function as a flow path and a valve.

The reaction unit 200 may include a heating device (not shown) that provides heat/temperature necessary for hydrolysis of chemical hydride or a separate purpose, or a cooling device (not shown) for discharging reaction heat when the hydrogen generating reaction is an exothermic reaction. For example, the heating device may use electricity or other heat source, and the cooling device may be implemented as a cooling water storage tank 230 to discharge heat generated by hydrolysis of chemical hydride. The cooling water storage tank 230 may maintain, for example, the temperature of the dehydrogenation reactor 210 at about 100° C. to about 400° C.

The reaction unit 200 may include a third pump 630 between the acid aqueous solution storage tank 220 and the dehydrogenation reactor 210. The third pump 630 supplies the acid aqueous solution from the acid aqueous solution storage tank 220 to the dehydrogenation reactor 210, and may control a supply flow of the acid aqueous solution. The third pump 630 may be disposed on a line connecting the acid aqueous solution storage tank 220 and the dehydrogenation reactor 210.

In addition, the reaction unit 200 may include a fourth pump 640 between the cooling water storage tank 230 and the dehydrogenation reactor 210. The fourth pump 640 supplies cooling water from the cooling water storage tank 230 to the dehydrogenation reactor 210 and may control a supply flow of the cooling water. The fourth pump 640 may be disposed in a line connecting the cooling water storage tank 230 with the dehydrogenation reactor 210.

In addition, the reaction unit 200 may include a second valve 720 for discharging pressurized hydrogen (e.g., about 2 bar or more) in the dehydrogenation reactor 210 to the hydrogen storage unit 300 and a fourth valve 730 for transporting the product to the recovery unit 400 by using the pressurized hydrogen or gravity. Optionally, the reaction unit 200 may include a pump (not shown) for transporting the product to the recovery unit 400 instead of the fourth valve 730.

The hydrogen storage unit 300 includes a hydrogen storage tank 310 for storing hydrogen produced in the dehydrogenation reactor 210. The hydrogen storage tank 310 receives and stores a predetermined amount of hydrogen gas. For example, the hydrogen storage tank 310 may be a buffer tank.

Optionally, the hydrogen storage unit 300 may further include a water trap 320, a methanator 330, a filter, or a combination thereof, for separating hydrogen from the mixed gas produced in the dehydrogenation reactor 210 at the front end of the hydrogen storage tank 310 (not shown).

As an example, the methanator 330 converts carbon monoxide produced as a by-product into methane when hydrogen is produced by a dehydrogenation reaction of a chemical hydride and an acid aqueous solution. The methanator 330 may be disposed between the dehydrogenation reactor 210 and the hydrogen storage tank 310.

The methanator 330 may include a gas conduit fluidly connected to the gas outlet of the dehydrogenation reactor 210, and a catalyst provided in the gas conduit. The catalyst may include at least one of nickel (Ni), ruthenium (Ru), cobalt (Co), rhodium (Rh), and iron (Fe). The catalyst is in a solid state, and for example, may be in the form of any one of granules, beads, microcapsules, and pellets. Such a catalyst is filled in the gas conduit, and as the gases of hydrogen and carbon monoxide discharged from the dehydrogenation reactor 210 pass through the catalyst, carbon monoxide is converted into methane. The methanation of carbon monoxide occurs under high-temperature conditions. For example, when a nickel catalyst is used, the methanation reaction takes place at about 300° C. or higher, and at about 340° C., most of carbon monoxide is converted into methane.

The recovery unit 400 recovers the product produced in the dehydrogenation reactor 210 and stores it in the product storage tank 410.

For example, the product may be NaHCO₂, Na₂B₄O₇·5H₂O, and H₂O produced by the dehydrogenation reaction in Reaction Scheme 1.

Since the removal is cumbersome when the product is solidified by cooling to room temperature in the dehydrogenation reactor 210, it can be recovered when the product is in a liquefied state at a temperature of greater than or equal to about 40° C., or greater than or equal to about 80° C.

The product storage tank 410 may include a fifth valve 750 for receiving and temporarily storing the mixed gas and product produced in the dehydrogenation reactor 210, and then transferring the mixed gas to the front end of the hydrogen storage unit 300.

The recovery unit 400 may include a drain valve configured to dissolve and discharge the product by injecting a solvent of greater than or equal to about 40° C., for example, hot water or a product solution (glycol), into the product storage tank 410 (820), or it is also possible to replace the product storage tank 410 itself as a cartridge.

In addition, the recovery unit 400 may reduce a weight of the product by evaporating and discharging moisture resulting from the product as needed (830), or may be transferred to the water storage tank 120 for recycling (840).

Optionally, the dehydrogenation device may further include a fuel cell 500.

The fuel cell 500 is located downstream of the hydrogen storage unit 300 and receives hydrogen gas from the hydrogen storage unit 300.

The fuel cell 500 generates water by reacting the supplied hydrogen with oxygen and simultaneously generates electrical energy. The water produced in the fuel cell 500 is discharged through exhaust means such as valves.

Alternatively, the water produced in the fuel cell 500 may be recovered and stored in the water storage tank 120 (850). In this case, the amount of water supplied to the water storage tank 120 may be adjusted by the fifth pump 650. Through this, because only a small tank capable of storing water is required, the volume and weight may be reduced to increase the hydrogen storage capacity of the dehydrogenation reaction device.

The fuel cell 500 may be any device that converts the hydrogen gas into usable electrical energy, and for example, it may be a proton exchange membrane fuel cell (PEMFC), an alkaline fuel cell (AFC), a phosphoric acid fuel cell (PAFC), a molten carbonate salt fuel cell (MCFC), or a solid oxide fuel cell (SOFC), etc., but the present disclosure is not limited thereto.

For example, the fuel cell 500 may pass the generated electrical energy through a power converter such as a DC converter, an inverter, or a charge controller. The power converter may output a portion of the electrical energy to an electrical load through a load interconnect, and the other portion of the electrical energy may be sent back to the energy storage through a recharging interconnect. Another portion of the electrical energy may be used to supply power to a control unit.

Optionally, the dehydrogenation reaction device transfers heat (about 80° C.) generated from the fuel cell 500, the dehydrogenation reactor 210, or a combination thereof to the water storage tank 120, efficiently preventing the water from freezing or melting the frozen water even at a low temperature to inject a required amount of water to the reactor without delay.

If necessary, the dehydrogenation reaction device may further include a pressure regulator (not shown) between the dehydrogenation reactor 210 and the hydrogen storage unit 300 and a mass flow meter (not shown) between the hydrogen storage unit 300 and the fuel cell 500.

In addition, the dehydrogenation reactor 210 may further include a sensor, a thermometer, or a pressure gauge inside or outside. Thereby, hydrogen gas may be stored in the hydrogen storage unit 300 at a constant pressure, and hydrogen gas may be supplied to the fuel cell 500 at a desired pressure and mass.

The conventional batch-type reactor may not be often restarted due to a product cooled to room temperature, but the dehydrogenation reaction device according to an embodiment may secure restartability by separating the reactant from the product.

In addition, when a cooling coil or the like is present inside the conventional batch-type reactor, the product, when solidified by cooling to room temperature, may hardly be removed due to the internal structure, but in the dehydrogenation reaction device according to an embodiment, the product storage tank provided separately from the reactor has no complicated connection of an injection unit, no internal structure, and no need to apply a thick material for a high-pressure reaction and thus may be easy to replace and also, convenient to remove a product. In addition, when the product storage tank also has a moisture removal function, a weight of the device may be reduced.

Furthermore, a conventional batch-type reaction is an uneven reaction between solid chemical hydride and liquid reactant, causing severe fluctuations in a hydrogen flow, but when the chemical hydride and the acid aqueous solution are simultaneously injected and reacted, the hydrogen flow is stabilized due to a reaction between aqueous solutions, and a flow of the aqueous solutions may be adjusted immediately to adjust and control an output.

In addition, since the conventional batch-type reactor is difficult to restart, as the reactor is larger, as the hydrogen storage tank has to be exponentially larger to store the hydrogen all at once reacted in the hydrogen storage tank, but the dehydrogenation reaction device according to an embodiment enables a continuous reaction, even if small, a size of the hydrogen storage tank also may be adjusted.

Hereinafter, specific examples of the present disclosure are presented. However, the examples described below are only for specifically illustrating or explaining the present disclosure, and the scope of the disclosure is not limited thereto.

### Preparation Example 1: Manufacturing of Dehydrogenation Reactor

A dehydrogenation reactor is fabricated according to configurations listed in Table 2 by using materials listed in Table 1 through the following process.

First, raw materials are prepared. A metal liner is sanded on the surface by using a sandblast and then, washed. The metal liner is assembled with a shaft for filament winding and then, mounted on a filament winding equipment. After carbon fiber is mounted on a filament winding tension equipment, a resin is filled into a resin bath. A filament winding pattern is loaded in the equipment.

A filament winding process is performed according to a stacking pattern.

In a dry oven, the obtained product is primarily molded (175±5° C., 5.5 hours). After completing the primary molding, the molding material is removed. In the dry oven, post-curing is performed (260±5° C., 5.5 hours). After completing the molding, the shaft, etc. are removed.

TABLE 1

| | Weight: 5.918 kg (excluding |
|---|---|
| | cooling coil) |
| Temperature/pressure | Glass transition temperature of |
| | resin: 335° C./225 bar |
| Metal of body portion | SUS316L |
| Fiber reinforced plastic | Carbon fiber |
| | Cyanate ester resin |

TABLE 2

| | Number | Weight | |
|---|---|---|---|
| Configuration of reactor | (EA) | (KG) | Note |
| Liner Assy | 1 | 7.680 | |
| Liner (Steel) | 1 | 4.688 | |
| Cooling Line | 1 | 2.550 | cooling coil volume |
| | | | 0.51 L |
| Inlet Line | 2 | 0.020 | |
| Swagelok (¾″) | 2 | 0.324 | |
| Swagelok (¼″) | 4 | 0.020 | |
| CFRP | 1 | 1.230 | |

| | | |
|---|---|---|
| Total | 8.910 | Effective internal |
| | | volume 4.86 L |

Referring to Table 2, a dehydrogenation reactor including a reinforcement portion, compared with a dehydrogenation reactor including no reinforcement portion withstanding the same pressure, may have a weight by 28% reduced by reducing a thickness of a body portion.

The manufactured dehydrogenation reactors are measured with respect to dimensional changes before and after pressurization, and the results are shown in Table 3. An overall length thereof is measured with a vernier caliper, and an exterior diameter thereof is measured with PI Tape.

TABLE 3

| | | | Exterior | Exterior | Exterior |
|---|---|---|---|---|---|
| Internal pressure | Pressure | Overall | diameter | diameter | diameter |
| test | [bar] | length | (front) | (center) | (rear) |
| Dimension before | 0 | 698.83 | 128.70 | 128.60 | 128.60 |
| pressurization | | | | | |
| [mm] | | | | | |
| Dimensions after | 100 | 693.74 | 128.60 | 128.60 | 128.70 |
| pressurization | 200 | 693.56 | 128.60 | 128.50 | 128.70 |
| [mm] | 225 | 693.73 | 128.60 | 128.60 | 128.70 |

Referring to Table 3, there is almost no dimensional deformation during the pressurization to a safety factor of 2.25 times of a normal pressure of 100 bars

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

1. A dehydrogenation reaction device, comprising
a chemical hydride storage unit including a chemical hydride storage tank;
a reaction unit including an acid aqueous solution storage tank, and a dehydrogenation reactor configured to generate hydrogen by reacting a chemical hydride with an acid aqueous solution; and
a hydrogen storage unit including a hydrogen storage tank configured to store the hydrogen produced in the dehydrogenation reactor;
wherein the dehydrogenation reactor includes a body portion made of a metal, and a reinforcement portion surrounding an outer surface of the body portion and including fiber reinforced plastic (FRP).

2. The dehydrogenation reaction device of claim 1, wherein
the metal of the body portion is a chemical-resistant metal including austenitic stainless steel or aluminum.

3. The dehydrogenation reaction device of claim 1, wherein
the fiber reinforced plastic includes a resin and a fiber within the resin,
wherein the resin includes:
an epoxy resin including phenolic glycidyl ethers, novolacs, aromatic glycidyl amines, aliphatics, cycloaliphatics, or hybrids thereof;
a cyanate ester resin including a tricyanate ester resin or a dicyanate ester;
a bismaleimide (BMI) resin; a polyimide (PI) resin;
or a combination thereof; and
wherein the fiber includes a carbon fiber, a glass fiber, an aramid fiber, a basalt fiber, a polyethylene terephthalate (PET) fiber, or a combination thereof.

4. The dehydrogenation reaction device of claim 3, wherein
the dicyanate ester resin includes a compound represented by 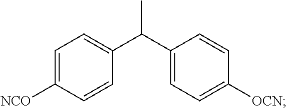
the tricyanate ester resin includes a compound represented by 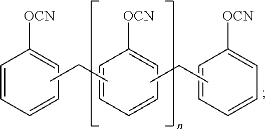
and
wherein n is an integer of 0 or 1.

5. The dehydrogenation reaction device of claim 3, wherein:
the resin has a viscosity of about 10 cps to about 20000 cps at room temperature (20° C.);
the resin includes a first resin and a second resin mixed at a weight ratio of about 10:90 to about 90:10;
the resin including the first resin and the second resin is primarily cured at about 100° C. to about 200° C. for about 30 minutes to about 360 minutes and then post-cured at about 200° C. to about 300° C. for about 30 minutes to about 360 minutes; and
the resin including the first resin and the second resin has a glass transition temperature (Tg) of about 100° C. to about 450° C.

6. The dehydrogenation reaction device of claim 1, wherein
the body portion of the dehydrogenation reactor includes:
a cylindrical cylinder portion;
a first hemispherical dome portion at a first end of the cylinder portion and a second hemispherical dome portion at a second end of the cylinder portion; and
a plurality of lines including a hydrogen discharge line at a first end of the first hemispherical dome portion or a first end of the second hemispherical dome portion, an acid aqueous solution supply line, a heat medium supply line, a heat medium discharge line, a product discharge line, a chemical hydride supply line, or a combination thereof; and
wherein the reinforcement portion surrounds at least a portion of the cylinder portion and the first and second hemispherical dome portions of the body portion.

7. The dehydrogenation reaction device of claim 6, wherein
the dehydrogenation reactor further includes a thermal control device configured to control an internal temperature of the dehydrogenation reactor, and
the heat control device is disposed in a coil shape along an inside or outside of the dehydrogenation reactor and includes a pipe line made of copper or steel.

8. The dehydrogenation reaction device of claim 7, wherein
one end of the first hemispherical dome portion of the dehydrogenation reactor further includes a heat medium supply line and a heat medium discharge line which are configured to supply and discharge a heat medium including an aqueous liquid refrigerant, an oil-based liquid refrigerant, a fluorine-based gas refrigerant, an inorganic compound-based gas refrigerant, or a combination thereof, flowing along the pipe line.

9. The dehydrogenation reaction device of claim 8, wherein
the first end of the first hemispherical dome portion or the first end of the second hemispherical dome portion of the dehydrogenation reactor further includes sensing lines configured to measure a temperature or pressure inside the dehydrogenation reactor.

10. The dehydrogenation reaction device of claim 9, wherein
the first end of the first hemispherical dome portion or the first end of the second hemispherical dome portion of the dehydrogenation reactor includes a manifold portion, and
wherein the hydrogen discharge line, the aqueous acid solution supply line, the heat medium supply line, the heat medium discharge line, the product discharge line, the chemical hydride supply line, the sensing line, or the combination thereof are located in the manifold portion.
